(19) United States
(12) Patent Application Publication
(10) Pub. No.: US 2006/0056019 A1
(43) Pub. Date: Mar. 16, 2006

(54) Binocular with motorized motorized optical adjustment

(76) Inventors: Mitchell L. Thomas, Klamath Falls, OR (US); Mark A. Thomas, Sisters, OR (US)

Correspondence Address: IPSOLON LLP, 805 SW BROADWAY, #2740, PORTLAND, OR, 97205, US

(21) Appl. No.: 10/937,951

(22) Filed: Sep. 10, 2004

(51) Int. Cl. G02B 23/00

(52) U.S. Cl. 359/425; 359/407

(57) ABSTRACT

A compact, light-weight binocular includes motorized optical adjust. The binocular includes a pair of telescopic sections connected to a bridge section positioned between them. Each telescopic section includes an eyepiece lens group, a prism element, an intermediate focus lens element, and a fixed objective lens. A high-speed focus motor and a speed-reduction gear assembly are positioned on the bridge section and operably coupled to the intermediate focus lens elements. A user-operated focus control is selectively operated by a user to activate the focus motor and adjust focus of the binocular.

### TECHNICAL FIELD

The present invention relates to optical binoculars and, in particular, to a binocular with a user-controlled motorized optical adjustment.

### BACKGROUND AND SUMMARY OF THE INVENTION

Optical binoculars are widely available. Binoculars include a pair of telescopic sections that are positioned side-by-side, often with a central bridge positioned between them. Many binoculars include a focus adjust knob that a user can manually turn to adjust focus of the binoculars.

Some binoculars include a motor drive mechanism to adjust focus or magnification. An example is described in U.S. Pat. No. 5,583,692 of Funatsu. With regard to motorized focus adjustment, Funatsu describes a binocular with a central bridge that contains a motor and a power source (e.g., batteries). Activation of the motor shifts position of the objective lenses of the binoculars.

A problem with motorized adjustments in binoculars is that such adjustments can require significant torque, particularly when the positions of large optical elements such as objective lenses are adjusted. These significant torques can require relatively large motors and power supplies. For example, the binocular described in the Funatsu patent appears to include 4 batteries, each typically having a nominal voltage of 1.5 volts. The size and weight of these motors and power supplies can make such binoculars relatively bulky and heavy to use. In addition, many small motors provide imprecise positioning, particularly when operating against a torque load. Imprecise positioning can be particularly disadvantageous with regard to optical adjustments because even slight imprecision can significantly affect optical performance (e.g., focus or clarity).

Accordingly, the present invention provides a compact, light-weight binocular with motorized optical adjust. In one implementation, the binocular includes a pair of telescopic sections connected to a bridge section positioned between them. Each telescopic section includes an eyepiece lens group, a prism element, an intermediate focus lens element, and a fixed objective lens. A high-speed focus motor and a speed-reduction gear assembly are positioned on the bridge section and operably coupled to the intermediate focus lens elements. A user-operated focus control is selectively operated by a user to activate the focus motor and adjust focus of the binocular.

The high rotational speed of the high-speed focus motor cooperates with speed-reduction gear assembly to provide precise motor-driven focus adjustments. In addition, the high-speed focus motor and speed-reduction gear assembly cooperate to increase the effective torque motor so that it can provide adjustments of intermediate focus lenses despite the compact size of the motor and voltage source. Furthermore, focus adjustments made to intermediate focus lenses requires less torque, and therefore a smaller motor, than would focus adjustments made to objective lenses that are larger and heavier and require weather-tight seals.

Additional description and implementations of the present invention will be apparent from the detailed description of the preferred embodiment thereof, which proceeds with reference to the accompanying drawings.

### BRIEF DESCRIPTION OF THE DRAWINGS

FIG. 1 is a top view of a binocular with a motorized focus adjustment according to the present invention.

FIG. 2 is a sectional top view of a binocular with a motorized focus adjustment according to the present invention.

FIG. 3 is a sectional side view of a binocular with a motorized focus adjustment according to the present invention.

FIG. 4 is a sectional end view of a binocular with a motorized focus adjustment according to the present invention.

FIG. 5 is another sectional end view of a binocular with a motorized focus adjustment according to the present invention.

FIG. 6 is a top view of a binocular with motorized focus and zoom adjustments according to the present invention.

FIG. 7 is a sectional top view of a binocular with motorized focus and zoom adjustments according to the present invention.

FIG. 8 is a sectional bottom view of a binocular with motorized focus and zoom adjustments according to the present invention.

FIG. 9 is a sectional side view of a binocular with motorized focus and zoom adjustments according to the present invention.

FIG. 10 is a sectional end view of a binocular with motorized focus and zoom adjustments according to the present invention.

FIG. 11 is an enlarged top plane view of a cam sleeve used in the zoom adjustment.

FIG. 12 is an enlarged illustration of a two-piece eyepiece lens group used in the zoom adjustment.

### DETAILED DESCRIPTION OF PREFERRED EMBODIMENTS

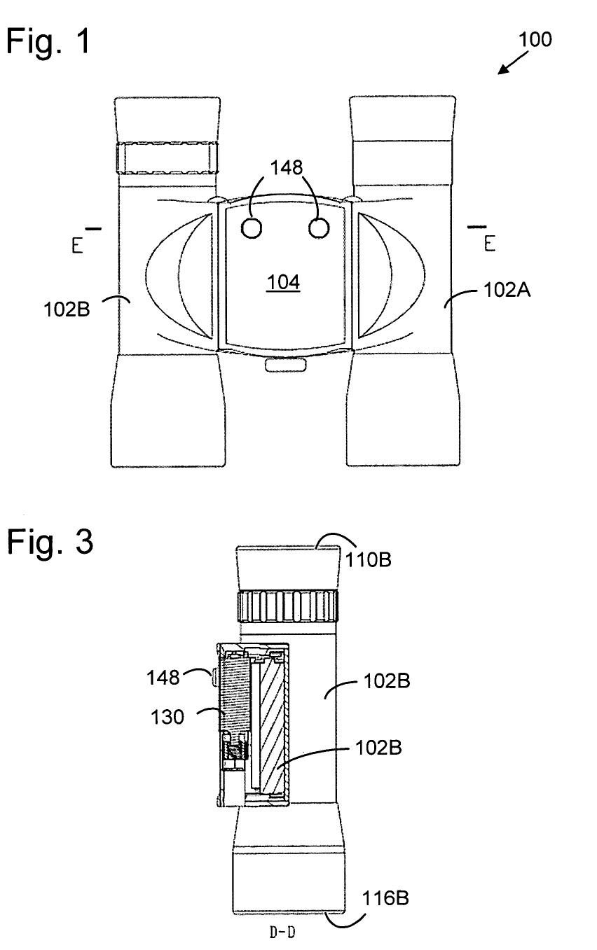

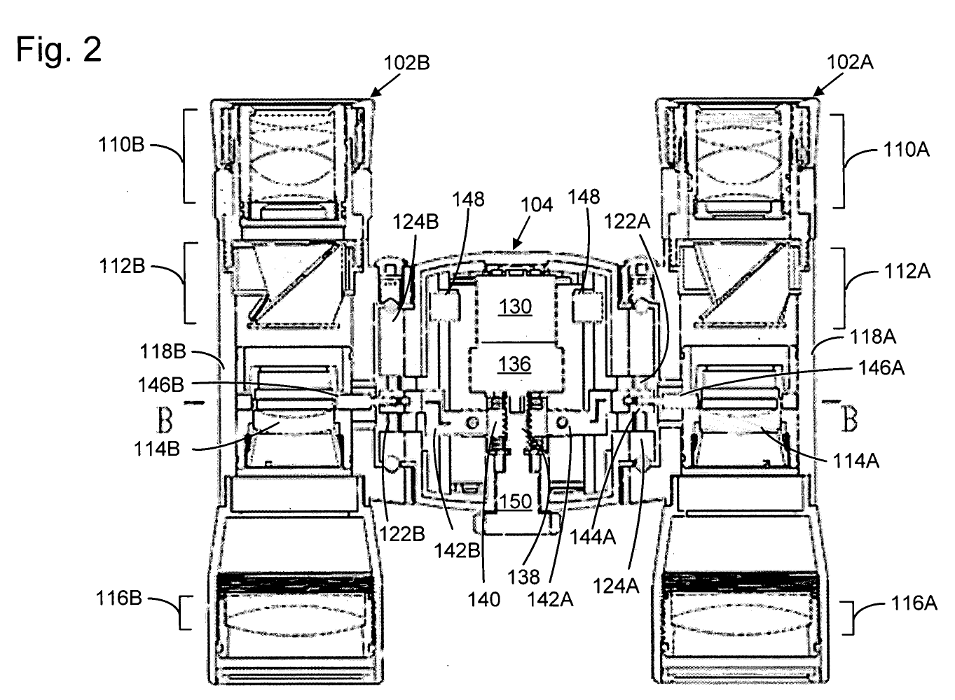

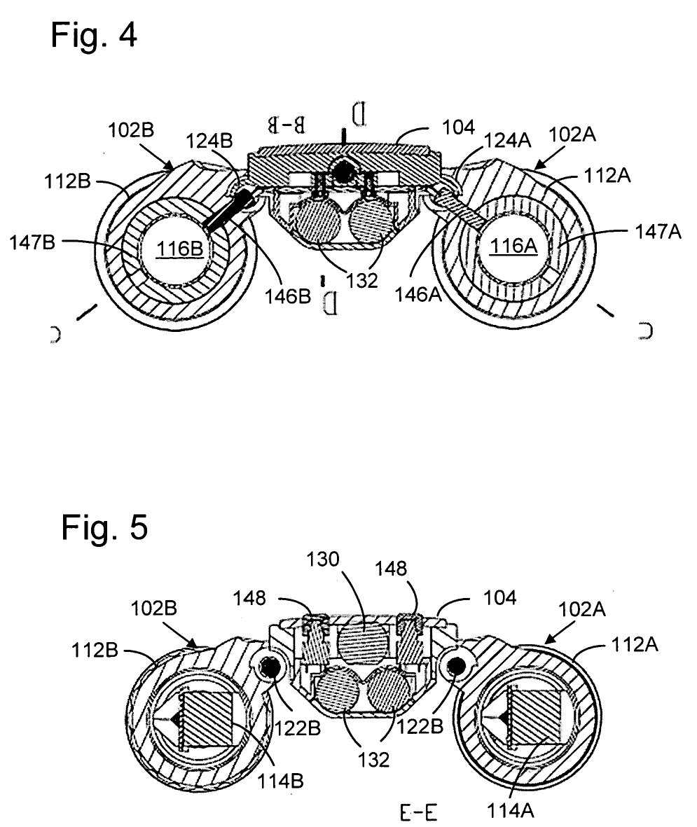

With reference to FIGS. 1-5, a binocular 100 has right-and left-side telescopic sections 102A and 102B with a central bridge 104 positioned between and connecting them. Telescopic sections 102A and 102B include common elements that are indicated by common reference numerals and the suffices A and B, respectively. The following description refers primarily to telescopic section 102A, but is similarly applicable to telescopic section 102B.

Telescopic section 102A includes in sequence an eyepiece lens group 110A, a prism element 112A, an intermediate focus lens element 114A (e.g., a Barlow lens), and a fixed objective lens 116A within a telescopic body 118A. Prism element 112A may include a roof prism, as illustrated, or may include a Porro prism or any other appropriate type of prism. Intermediate focus lens element 114A may be implemented as a lens singlet, as illustrated, or may be implemented as a multiple lens structure. Telescopic section 102A is pivotally connected to central bridge 104 by a hinge 120A having a pin 122A that fits within at least a pair of sleeves 124A. Each sleeve 124A is fixed to one of telescopic body 118A and central bridge 102 and is pivotable about pin 122A.

A compact, bidirectional, low-voltage, high-speed focus motor 130 is mounted to (e.g., within) central bridge 104 with a voltage source 132. For example, voltage source 132 may include a pair of AAA-size batteries that together provide a nominal voltage of up to about 3 volts. Focus motor 130 includes a drive shaft 134 that is rotatable at a high speed of between about 5,000 and 20,000 RPM (e.g., 8000 PRM) with power from voltage source 132. Focus motor 130 is compact in that its main body, not including drive shaft 134, may have dimensions of about 25 mm×12 mm×10 mm, +5 mm in each dimension.

Drive shaft 134 is coupled via a speed-reduction gear assembly 136 to a focus drive screw 138. For example, speed-reduction gear assembly 136 reduces rotational speed from drive shaft 134 so that drive screw 138 rotates at about 15 RPM, for example. In one such implementation, focus may be changed from 1 meter to infinity in about 5 seconds. It will be appreciated, however, that other speed reductions ratios could alternatively be used.

Drive screw 138 is in threaded engagement with a collar 140 with arms 142A and 142B that extend toward hinges 120A and 120B, respectively. Arm 142A includes a pair of fingers 144A that are slidably coupled to pin 122A. One end of an arm extension 146A is slidably connected to pin 122A between fingers 144A, and another end or arm extension 146A is fixedly coupled to a holder 148A that holds intermediate focus lens element 114A. Holder 148A is slidable within telescopic body 118A.

A pair of user-operable focus control buttons 148 allow a user to selectively change focus of binocular 100. User-activation of one of buttons 148 applies a voltage of a first polarity to high-speed focus motor 130. The first voltage polarity results in rotation of drive shaft 134 and drive screw 138 in a first rotational direction (e.g., clockwise), thereby moving collar 140 and intermediate focus lenses 114A and 114B in a first lateral direction (e.g., forward, toward fixed objective lenses 116A and 116B). User-activation of the other of buttons 148 applies a voltage of a second polarity to high-speed focus motor 130. The second voltage polarity results in rotation of drive shaft 134 and drive screw 138 in a second rotational direction (e.g., counter-clockwise), thereby moving collar 140 and intermediate focus lenses 114A and 114B in a second lateral direction (e.g., backward, away from fixed objective lenses 116A and 116B). It will be appreciated that as an alternative to a pair of control switches 148, a single toggle switch could alternatively be used.

The high rotational speed of high-speed focus motor 130 cooperates with speed-reduction gear assembly 136 to provide precise motor-driven focus adjustments. In addition, high-speed focus motor 130 and speed-reduction gear assembly 136 cooperate to increase the effective torque motor 130 so that it can provide adjustments of intermediate focus lenses 114A and 114B despite the compact size of motor 130 and voltage source 132. Furthermore, focus adjustments made to intermediate focus lenses 114A and 114B requires less torque, and therefore a smaller motor 130, than would focus adjustments made to objective lenses 116A and 116B which are larger and heavier and require weather-tight seals.

In one implementation, for example, binocular 100 could employ objective lenses 116A and 116B each with a clear aperture diameter of 28 mm, even with compact motor 130 and voltage source 132 both being positioned above the centers of objective lenses 116A and 116B. Such a configuration allows even a binocular 100 with relatively small objectives 116A and 116B to maintain the compact feel of a conventional manual binocular with comparable objectives.

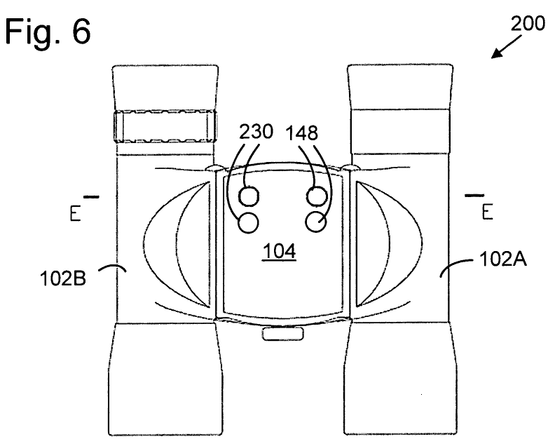

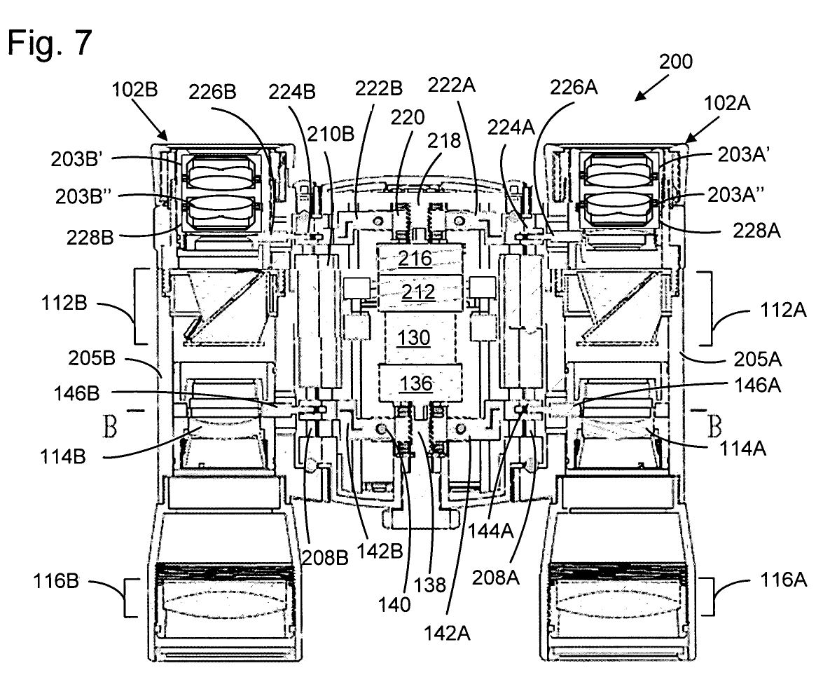

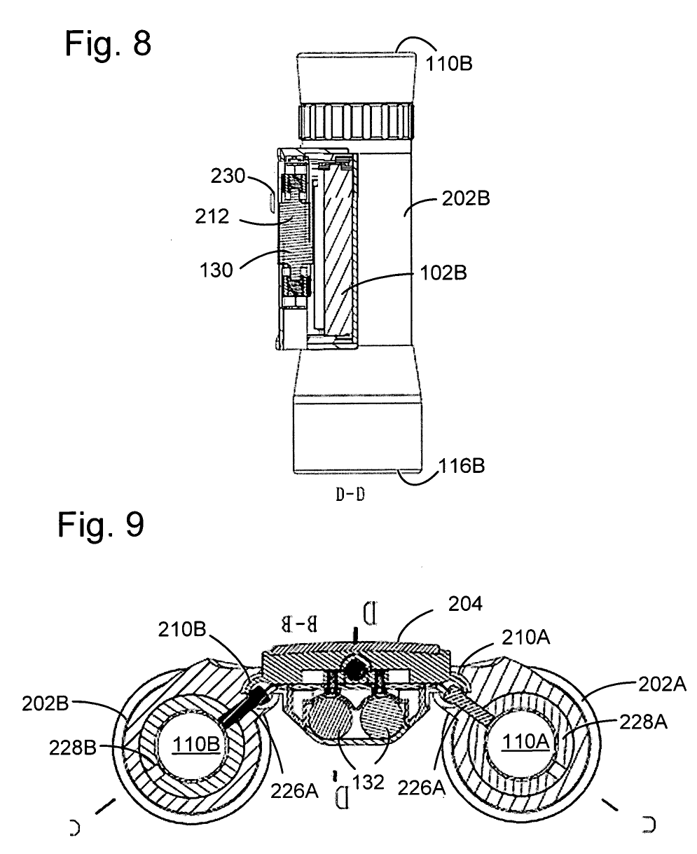

FIGS. 6-10 show a binocular 200 that includes components that are substantially the same as those of binocular 100, with features common to both binoculars identified by the same reference numerals. Binocular 200 has right-and left-side telescopic sections 202A and 202B with a central bridge 204 positioned between and connecting them.

With reference to telescopic section 202A, eyepiece lens groups 203A′ and 203A″, a prism element 112A, an intermediate focus lens element 114A (e.g., a Barlow lens), and a fixed objective lens 116A are positioned in sequence within a telescopic body 205A. Eyepiece lens groups 203A′ and 203A″ are different from eyepiece lens group 110A and are described below in greater detail. Telescopic section 202A is pivotally connected to central bridge 204 by a hinge 206A having a pin 208A that fits within at least a pair of sleeves 210A. Each sleeve 208A is fixed to one of telescopic body 205A and central bridge 204 and is pivotable about pin 208A.

Binocular 200 includes motorized focus adjustment elements that are substantially the same as those of binocular 100. In addition, binocular 200 further includes a compact, bi-directional, low-voltage, high-speed zoom motor 212 that is mounted to (e.g., within) central bridge 204 and in electrical communication with voltage source 132. Zoom motor 212 is substantially the same and provides the same benefits as motor 130. Zoom motor 212 includes a drive shaft 214 that is coupled via a speed-reduction gear assembly 216 to a zoom drive screw 218. Speed-reduction gear assembly 216 may be substantially the same as speed-reduction gear assembly 136.

Drive screw 218 is in threaded engagement with a collar 220 with arms 222A and 222B that extend toward hinges 206A and 206B, respectively. Arm 222A includes a pair of fingers 224A that are slidably coupled to pin 208A. One end of a cam arm 226A is slidably connected to pin 208A between fingers 224A, and another end or arm extension 226A is slidably engaged with a rotating cam sleeve 228A that holds eyepiece lens groups 203A′ and 203A″

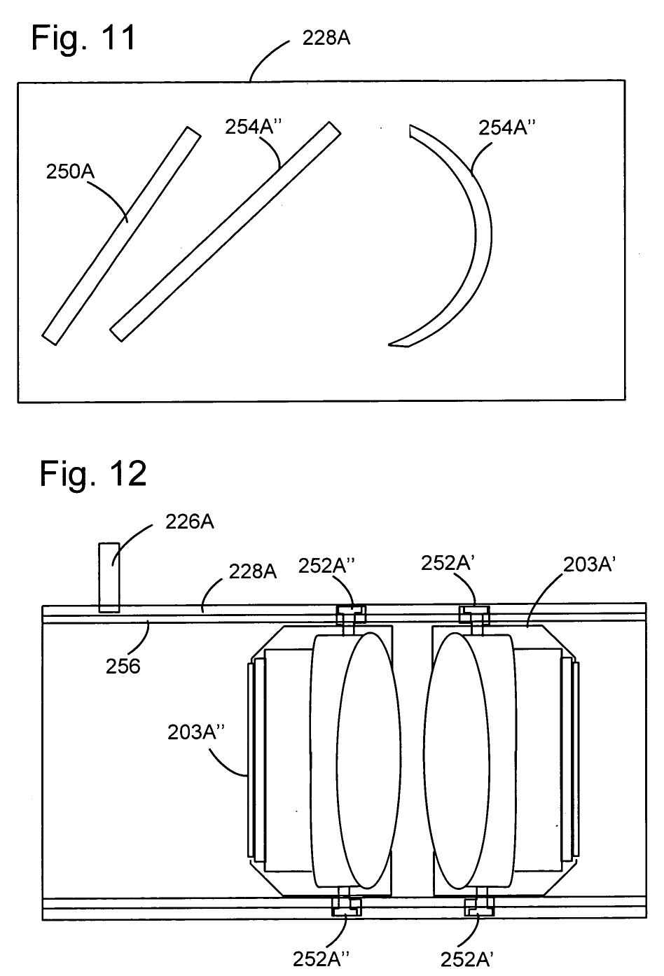

FIG. 11 is an enlarged top plane view of cam sleeve 228A, which includes an angled cam drive slot 250A in which cam arm 226A fits and is slidable along so that axial motion of cam arm 226A induces rotation of cam sleeve 228A. With additional reference to FIG. 12, eyepiece lens groups 203A′ and 203A″ include cam pins 252A′ and 252A″ that slidably engage eyepiece cam slots 254A′ and 254A″ in cam sleeve 228A, respectively. Cam pins 252A′ and 252A″ extend through an axial slot in an eyepiece main body 256. The axial slot prevents eyepiece lens groups 203A′ and 203A″ from rotating when cam sleeve 228A is rotated by motion of cam arm 226A. Rotation of cam sleeve 228A causes cam pins 252A′ and 252A″ to move in respective eyepiece cam slots 254A′ and 254A″, thereby moving eyepiece lens groups 203A′ and 203A″ toward or away from each other to adjust the power.

A pair of user-operable focus control buttons 230 allow a user to selectively change magnification, or zoom, of binocular 200. User-activation of one of buttons 230 applies a voltage of a first polarity to high-speed zoom motor 212. The first voltage polarity results in rotation of drive shaft 214 and drive screw 218 in a first rotational direction (e.g., clockwise), thereby moving collar 240 and eyepiece lens groups 203A′, 203A″, 203B′, and 203B″ in a first axial direction (e.g., rearward, away from fixed objective lenses 116A and 116B). User-activation of the other of buttons 230 applies a voltage of a second polarity to high-speed focus motor 212. The second voltage polarity results in rotation of drive shaft 214 and drive screw 218 in a second rotational direction (e.g., counter-clockwise), thereby moving collar 220 and eyepiece lens groups 203A′, 203A″, 203B′, and 203B″ in a second axial direction (e.g., forward, toward fixed objective lenses 116A and 116B). It will be appreciated that as an alternative to a pair of control switches 230, a single toggle switch could alternatively be used.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. A binocular, comprising:
a pair of telescopic sections connected to a bridge section positioned between them, each telescopic section including an eyepiece lens group, a prism element, an intermediate focus lens element, and a fixed objective lens,
a high-speed focus motor and a speed-reduction gear assembly positioned on the bridge section and operably coupled to the intermediate focus lens elements; and
a user-operated focus control for selective operation by a user to activate the focus motor and adjust focus of the binocular.

2. The binocular of claim 1 in which the high-speed focus motor includes a drive shaft and activation of the motor spins the drive shaft at between about 5,000 and 20,000 RPM.

3. The binocular of claim 1 in which the pair of telescopic sections are connected to the bridge section with respective hinges, the high-speed focus motor and the speed-reduction gear assembly being operably coupled to the intermediate focus lens elements through the respective hinges.

4. A binocular, comprising:
a pair of telescopic sections connected to a bridge section positioned between them, each telescopic section including an eyepiece lens group, a prism element, an intermediate focus lens element, and a fixed objective lens;
a first high-speed motor and a first speed-reduction gear assembly positioned on the bridge section and operably coupled to at least one of the intermediate focus lens elements and the eyepiece lens groups; and
a first user-operated binocular control for selective operation by a user to activate the first motor and adjust the binocular.

5. The binocular of claim 4 in which the first high-speed motor and first speed-reduction gear assembly are operably coupled to the eyepiece lens groups to adjust magnification of the binocular.

6. The binocular of claim 4 in which the first high-speed focus motor includes a drive shaft and activation of the motor spins the drive shaft at between about 5,000 and 20,000 RPM.

7. The binocular of claim 5 further comprising:
a second high-speed motor and a second speed-reduction gear assembly positioned on the bridge section and operably coupled to the intermediate focus lens elements and the eyepiece lens groups to adjust focus of the binocular; and
a second user-operated binocular control for selective operation by a user to activate the first motor and adjust the binocular.

8. The binocular of claim 7 in which the first and second high-speed motors each includes a drive shaft and activation of each motor spins its drive shaft at between about 5,000 and 20,000 RPM.

9. The binocular of claim 4 in which the pair of telescopic sections are connected to the bridge section with respective hinges, the first high-speed motor and the speed-reduction gear assembly being operably coupled to the intermediate focus lens elements through the respective hinges.

10. A binocular, comprising:
a pair of telescopic sections connected to a bridge section positioned between them, each telescopic section optical elements that include an eyepiece lens group, a prism element, an intermediate focus lens element, and a fixed objective lens;
a high-speed motor and a speed-reduction gear assembly positioned on the bridge section and operably coupled to matching optical elements in each of the telescopic sections; and
a first user-operated binocular control for selective operation by a user to activate the motor and adjust the binocular.

11. The binocular of claim 10 in which the high-speed motor and speed-reduction gear assembly are operably coupled to the intermediate focus lens element in each of the telescopic sections.

12. The binocular of claim 10 in which the high-speed motor and speed-reduction gear assembly are operably coupled to the eyepiece lens group in each of the telescopic sections.

13. The binocular of claim 10 in which the high-speed focus motor includes a drive shaft and activation of the motor spins the drive shaft at between about 5,000 and 20,000 RPM.
